(19) United States
(12) Patent Application Publication
(10) Pub. No.: US 2010/0062233 A1
(43) Pub. Date: Mar. 11, 2010

(54) METHODS FOR CONVERTING USED PAPER MATERIAL INTO STRUCTURAL PANELS, AND STRUCTURAL PANELS MADE THEREBY

(76) Inventors: Myles Cohen, Columbia, SC (US); Terry Gerhardt, Hartsville, SC (US); Lawrence E. Renck, Hartsville, SC (US); John Whitehead, Hartsville, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/529,441

(22) PCT Filed: Mar. 7, 2008
(86) PCT No.: PCT/US08/03080

§ 371 Date: Sep. 1, 2009

(51) Int. Cl. B32B 9/06; B32B 7/12; B32B 3/26; B32B 7/02; B32B 38/00

(52) U.S. Cl. 428/212; 428/537.5; 428/332; 428/304.4; 428/486; 428/452; 156/256

(57) ABSTRACT

A method for reusing used paper material such as paperboard cartons comprises the steps of collecting used paper material after it has been used for its original purpose, dividing the used paper material into pieces without repulping the used paper material, coating an adhesive material onto the pieces, and assembling the coated pieces together into a layer to form a structural panel, the adhesive material binding the pieces together upon curing or drying. The pieces can be long narrow strips and/or shredded pieces and/or fiberized pieces that are essentially randomly oriented in the structural panel.

### BACKGROUND OF THE INVENTION

The present disclosure relates generally to structural panels made substantially from paper as an alternative to conventional structural panels made substantially from wood (e.g., particle board) or substantially from a mineral material (e.g., gypsum board, also known as sheetrock or drywall). In one aspect, a structural panel in accordance with the present disclosure can be used as a building construction panel, as a structural layer in a laminated sandwich panel (e.g., a table top or countertop), or the like. In another aspect, a structural panel can be used as a shipping member used for shipping goods from one location to another, as an alternative to a traditional wood pallet.

Paperboard containers made from corrugated or non-corrugated paperboard are widely used for shipping products from manufacturers or distributors to retailers and other destinations. Other paper materials such as newsprint for advertising flyers, paper used as cushioning in cartons, and the like, are also widely used in industry. Once the paper materials have been used for their intended purpose, they are generally regarded as waste. In some cases, the used paper materials are simply disposed of along with other waste. In other cases, the user or recipient of the used paper materials may send the used paper materials to a recycler, at which the used paper materials are shredded and/or baled and then shipped to a paper mill. The paper mill can repulp the used paper materials to make recycled paper, which can then be converted into products of various types.

However, these recycling steps add significant cost to a material that is already of relatively low commercial value.

The shipping of products from manufacturers to distributors generally entails the use of shipping members (e.g., pallets, trays, etc.) for supporting and palletizing the products so that the products can easily be moved about using forklifts and the like. It is estimated that in the United States, presently there are approximately 1.4 billion pallets in circulation. The overwhelming majority of these pallets are conventional wood pallets made from wood boards nailed together. In the United States alone, approximately one million acres of timber go into the manufacturing of wood pallets per year. Wood pallets are difficult to dispose of after they have exhausted their useful life. It is estimated that approximately 120 million wood pallets are going to landfills each year. Currently it costs approximately one dollar per pallet to dispose of conventional wood pallets. Many landfills, however, are no longer accepting pallets. Thus, wood pallets represent a significant burden on the environment.

Apart from the environmental disadvantages, wood pallets are heavy, typically weighing as much as 70 pounds. As a consequence, a significant portion of the cost for shipping products is due to the weight of the pallets.

Additionally, wood pallets are relatively expensive to manufacture. The raw materials for a typical wood pallet cost approximately $4.50 to $5.75, to which the cost of labor for assembling the pallet must be added.

It is also common in the shipping of certain types of products to include protective members made from cardboard or paperboard in the carton. Such protective members can include, for example, L-shaped corner protectors, edge boards, and the like. Protective members made from paper typically are either disposed of after use, or are sent for repulping and recycling, which as already noted is not a very cost-effective way to reuse these used paper materials.

Furthermore, in the construction industry, structural panels comprising gypsum board (i.e., sheetrock or drywall) or particle board are widely used. Particle board is also used in the furniture industry.

A significant drawback associated with most or all of the aforementioned structural panels (particularly wood pallets and gypsum board) is that they are not readily recyclable in an economically attractive way.

### BRIEF SUMMARY OF THE DISCLOSURE

The present disclosure describes an alternative manner of reusing used paper materials to make them into structural panels, thereby recycling them at reduced cost in comparison with the traditional recycling scheme involving repulping and papermaking. In accordance with the development described herein, a structural panel comprises a plurality of pieces of used paper material produced by dividing used paper material into pieces, with adhesive material being coated onto the pieces of used paper material, the coated pieces of used paper material being assembled together into a layer to form a structural panel. In some embodiments disclosed herein, the pieces are respectively randomly oriented in a multitude of different orientations within the layer.

A method for reusing used paper material (e.g., cardboard cartons, paper, etc.) comprises the steps of collecting the used paper material after the used paper material has been used for its primary purpose, dividing the used paper material into pieces, applying an adhesive material to the pieces, and assembling the pieces together to form a structural panel, the adhesive material binding the pieces together upon curing or drying of the adhesive material, whereby the structural panel is formed without repulping the used paper material. The structural panels can be used, for example, as pallets, as construction panels, as cores for sandwich panels (e.g., wall board, furniture panels, cabinet panels, countertops, etc.), and the like.

A significant advantage of the present development is that the used paper material can be “contaminated” paper material that conventionally is not readily recyclable, such as plastic-coated or wax-coated paperboard.

In one embodiment, the dividing step comprises dividing the used paper material into long narrow strips. The strips are bonded together with the adhesive material to form a structural panel, with the orientations of the strips being essentially random.

Advantageously the structural panel is made in a continuous process wherein the used paper material pieces coated with adhesive material are continuously deposited onto a moving surface to form a layer of the adhesive-coated pieces, and the layer is compressed between the moving surface and an upper member to consolidate the pieces and form the layer into a panel of desired thickness.

In one embodiment, the moving surface onto which the layer of adhesive-coated pieces is deposited comprises a sheet that will form one face sheet of a laminated structural panel. A second face sheet can be adhered to the opposite side of the layer, thus forming a three-layer laminated structural panel. The face sheets can comprise any of various materials. In one embodiment the face sheets comprise paper or paperboard made from recycled paper fibers. A laminated structural panel made in this manner can serve as a replacement for conventional gypsum board or particle board.

In a further embodiment, the dividing step comprises dividing the used paper material into substantially flat pieces larger than about 4×4 inches. The pieces are stacked to form a structural panel as a laminate made up of the pieces. At least some of the flat pieces can be of smaller width and/or length dimensions than the structural panel and can be stacked so as to partially overlap with one another.

In another embodiment, the dividing step comprises dividing the used paper material into pieces smaller than about 4×4 inches, and the pieces with the adhesive material are placed into a mold and pressed in the mold to form the structural panel. The mold can form the structural panel to be substantially planar, after which separate feet can be attached to the structural panel if it is to be used as a pallet. Alternatively, the mold can form the structural panel to have integral feet. The dividing step can comprise shredding the used paper material. Alternatively, the dividing step can comprise fiberizing the used paper material.

In accordance with the present disclosure, by omitting the typical repulping of the used paper material, the manufacture of recycled paper, and the converting operations for making paper products from the recycled paper, the added costs associated with these steps are avoided. Accordingly, additional use can be extracted from the used paper material at a substantially lower cost. The structural panels of the present invention can be made to possess a strength-to-weight ratio that compares very favorably with that of gypsum board and particle board, and it is expected that the manufacturing cost can also compare favorably in view of the low cost of the used paper material of which the panels are principally made.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic representation of an apparatus and process for the continuous production of structural panels in accordance with one embodiment of the present invention;

FIGS. 2A and 2B are photographs of a sample of a structural panel in accordance with one embodiment of the invention, with one face sheet partially peeled back to show the core layer formed of randomly oriented long narrow strips of adhesive-coated corrugated cardboard;

FIG. 3 is an exploded perspective view of a structural panel for use as a shipping member in accordance with an embodiment of the invention;

FIG. 4 is an exploded perspective view of a shipping member in accordance with a further embodiment of the invention;

FIG. 5 is a perspective view of a shipping member in accordance with another embodiment of the invention;

FIG. 6 is a perspective view of a shipping member in accordance with yet another embodiment of the invention;

FIG. 7 is a perspective view of a shipping member in accordance with a further embodiment of the invention;

FIG. 8 is a perspective view of a shipping member in accordance with a further embodiment of the invention; and

FIG. 9 is a perspective view of a shipping member in accordance with a still further embodiment of the invention.

### DETAILED DESCRIPTION OF THE DRAWINGS

The present invention now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in the description and claims, “paper” means a sheet of one or more layers of material each formed by depositing an aqueous pulp of cellulose fibers (and optionally one or more additives such as clay, starch, etc.) onto a forming wire or the like and removing the water to form a layer as a network of the fibers held together by hydrogen bonding between the fibers. Thus, the term “paper” includes but is not limited to paper, paperboard, cardboard, and corrugated cardboard made from any suitable fibers. The term “used paper material” means paper that has already been used at least once for its originally intended purpose, and thus includes but is not limited to old corrugated cardboard (“OCC”), office waste paper, used non-corrugated cartons, and the like.

Conventionally, when a retailer empties paperboard cartons containing new products shipped to the retailer from the manufacturer or distributor, the cartons are flattened and when a substantial quantity of the flattened cartons and other used paper material have been collected, they are either trucked from the retailer to a landfill for disposal or are sold to a recycling center. The recycling center may shred the used paper material and then bale them, or may bale the used paper material without first shredding them, and the bales of used paper material are then shipped to a paper mill where they are used for making recycled paper products. The used paper material conventionally must be repulped in order to make new paper products.

The present development allows used paper material to be made into new useful products without having to repulp the used paper material. In particular, in accordance with the present development, used paper material is made into structural panels that can be used as shipping members such as pallets, trays, corner protectors, edge boards, and the like, as construction panels such as wall board, as furniture or cabinet panels, as table tops, as countertops, or the like.

The method of making a structural panel from used paper material basically entails dividing the used paper material into pieces by any of a number of suitable techniques as further described below, applying an adhesive material to the pieces, and then assembling the pieces together into a layer to form a structural panel. The adhesive material binds the pieces together upon curing or drying. In this manner, a structural panel is formed without repulping the used paper material.

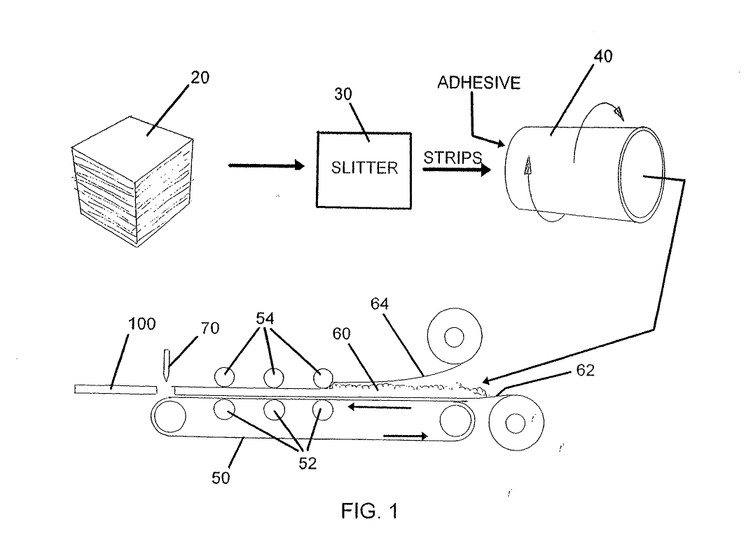

A process and apparatus for making structural panels in accordance with one embodiment of the invention is shown diagrammatically in FIG. 1. The illustrated process is a continuous process in which a structural panel is continuously formed as an advancing web that is advanced along a machine direction and can have any desired length in the machine direction. The process employs a quantity of used paper material 20, which can be any of various types of used paper material. In one embodiment the used paper material is OCC. Typically most OCC comprises double-faced corrugated board having a middle layer of corrugated paperboard sandwiched between two non-corrugated paper face sheets. The process of FIG. 1 however can also be used with single-faced corrugated board, with non-corrugated paperboard, with waste paper, and with mixtures of two or more of such materials.

In a first step of the process, the used paper material 20 is divided into pieces. Preferably a slitter 30 is employed to slit the used paper material into strips whose lengths are substantially greater than their widths. For example, the strips can have a length-to-width ratio between about 5:1 and about 50:1. When the used paper material is OCC, the slitter preferably slits the OCC such that the length direction of the strips is non-parallel to (and preferably perpendicular to) the direction in which the flutes of the corrugated layers extend. Slitting the OCC in this manner results in the strips having a plurality of “cells” formed between the corrugated layers and the face sheets.

Next, the strips of used paper material are fed into a drum mixer 40 or the like, along with adhesive material, and the strips are tumbled and mixed with the adhesive material so that the strips are sufficiently coated with adhesive material to allow them to adhere to one another. As an alternative to using a drum mixer, any other suitable device and technique can be used to achieve such coating of the strips.

The adhesive-coated strips of used paper material are then continuously deposited onto a moving surface such as a conveyor belt 50 to form a continuous layer 60 of the adhesive-coated strips. Any suitable technique and device can be used for continuously depositing the adhesive-coated strips. As one example, the strips can be depositing using a process similar to extruding, by pumping a stream of the adhesive-coated strips through a die slot or the like. The layer 60 can be deposited directly onto the surface of the belt 50 when the structural panel is to consist only of the layer 60. Alternatively, as shown, a continuous sheet 62 can be unwound from a roll and continuously fed onto the conveyor belt 50, and the layer 60 of adhesive-coated strips can be deposited onto the sheet 62. The adhesive on the strips may be sufficient to adhere the layer 60 to the sheet 62; alternatively, an additional adhesive can be applied to the surface of the sheet 62 before the adhesive-coated strips are deposited thereon. The layer 60 and sheet 62 form a continuous laminate.

A second continuous sheet 64 similarly can be unwound from a roll and continuously fed onto the upper surface of the layer 60 (again, either with or without application of additional adhesive to the sheet 64) in order to form a continuous three-layer sandwich panel having a core layer 60 of the adhesive-coated strips and face sheets 62, 64. The face sheets are useful for providing smooth surfaces to the sandwich panel, and also can enhance the bending stiffness of the panel.

The continuous panel is advanced by the conveyor belt 50 through a nip defined between a lower pressure member 52 and an upper pressure member 54. The nip has a predetermined thickness corresponding to the desired thickness of the panel. In the illustrated embodiment each of the pressure members comprises a roller. Furthermore, there is a series of three pairs of rollers 52, 54. The series of nip roller pairs can define progressively smaller nip thicknesses for progressively compressing the panel in three steps. Alternatively, any other suitable device can be used for compressing the panel to consolidate the layer of adhesive-coated strips and to achieve the desired thickness for the panel.

Although not shown, it will be understood that the apparatus and process can also employ any suitable type of heating/drying device for speeding up the drying or curing of the adhesive material used in the panel.

Finally, the continuously formed advancing panel is cut to any desired length by a suitable cutting device 70. Additionally, further cutting devices (not shown) can be used for trimming off side edge portions of the panel to form clean planar side edges, if desired. The resulting structural panel 100 can be used in various applications. For example, the panel 100 can replace conventional gypsum board or sheetrock, and can offer distinct advantages over gypsum board. In particular, the panel 100 is formed from used paper material, which is a renewable resource, unlike the calcined gypsum plaster used in the core of conventional gypsum board. Additionally, when the proper adhesive is used in sufficient amount for coating the used paper material strips, the panel 100 can achieve substantial water resistance and/or fire resistance. Advantageously, a silicate adhesive such as sodium silicate adhesive can be used for such purposes.

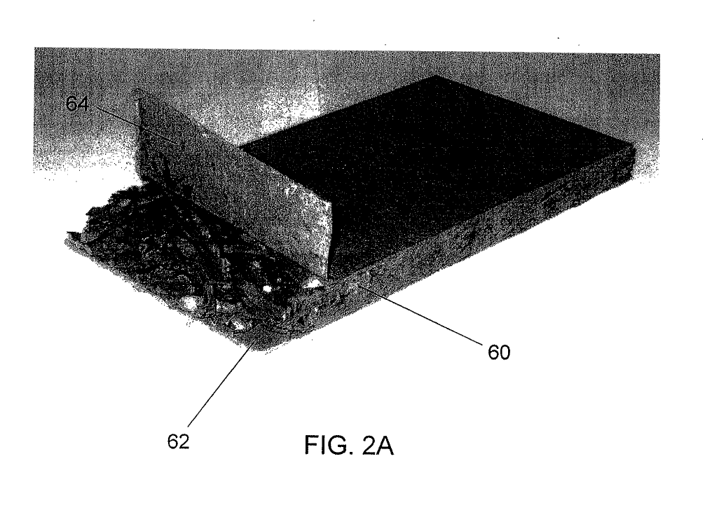

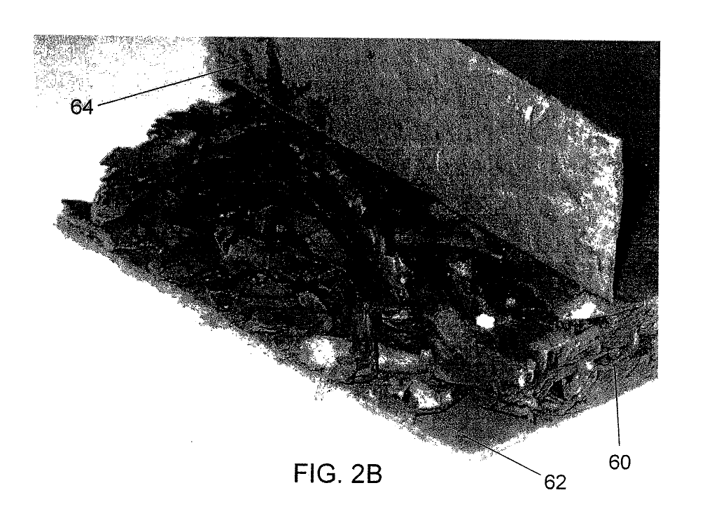

FIGS. 2A and 2B are photographs of a sample structural sandwich panel in accordance with one embodiment of the invention. The panel comprises a core layer 60 and opposite face sheets 62, 64. The top face sheet 64 is partially peeled back to show details of the core 60. The depicted panel has a thickness of approximately 11 mm (about ⅜-inch). The face sheets 62, 64 each has a thickness of about 0.7 mm (about 0.025 inch) and is formed of paperboard made from recycled paper fibers. The core 60 is formed of strips of randomly oriented double-faced corrugated board coated with a sodium silicate adhesive. The strips have a width of about 3 mm (about ⅛-inch) and a length at least about five times the width. The strips are slit perpendicular to the flutes of the corrugated board such that cells are formed in the strips. The adhesive can penetrate into the cells if a sufficient quantity of adhesive is used, thereby enhancing the stiffness of the panel. Alternatively, at reduced adhesive levels, the cells can form air-containing voids that, together with the voids formed between the randomly oriented strips, can provide the panel with a relatively low density while achieving substantial stiffness.

The exemplary panel shown in FIGS. 2A and 2B is merely one example of a panel structure that can be made in accordance with the invention. However, the invention is not limited to any particular configuration. For example, while the illustrated structural panel is planar on both of its opposite surfaces, alternatively one or both surfaces could be non-planar. This could be accomplished in various ways. For instance, in a continuous process such as shown in FIG. 1, the pressure members 52, 54 could be configured to impart a non-planar surface to one or both surfaces of the panel. Alternatively, the panels could be made in a batch process in a mold, and the mold could be configured with any desired configuration.

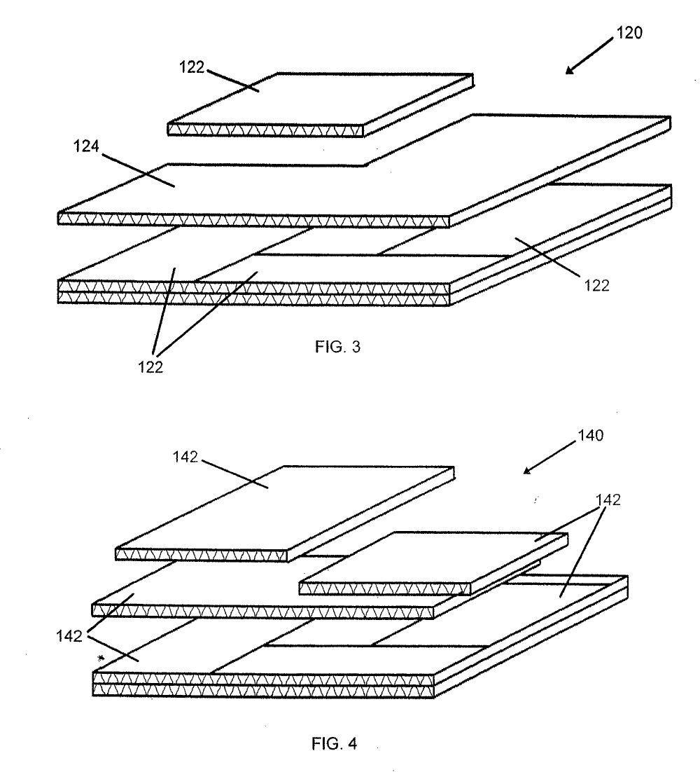

As noted, the structural panels can be used in various construction, furniture, cabinet, or similar applications where gypsum board or particle board are conventionally used. The structural panels in accordance with the present invention can also be used as shipping members such as a pallet. FIG. 3 depicts the fabrication of a shipping member in the form of a pallet 120, in accordance with a further embodiment of the invention. In this embodiment, the sheets of the used paper material (e.g., OCC or other paperboard cartons that have been flattened) are cut into pieces 122, 124 of substantial width and length dimensions (e.g., greater than about 4×4 inches, and more preferably greater than about 12×12 inches), and the pieces are of different sizes and shapes. Preferably the used paper material is divided into pieces while it is in a dry state. Some sheets of the used paper material may be large enough to provide pieces that match the desired length and width of the deck of the shipping member. For example, if the deck is to be 4×4 feet, there may be some sheets of used paper material large enough to provide pieces 4×4 feet in size. More commonly, however, the pieces will be smaller in width and/or length than the deck. The pieces are cut to have complementary shapes (generally rectangular or square, although other shapes such as the L-shaped piece 124 shown in FIG. 3 could be used) such that they fit together in a “jigsaw” fashion so as to form the deck of desired width and length dimensions and desired thickness. Generally, at least some of the pieces should have a longer dimension (i.e., the longer of the width and length) that is equal to the width of the deck, and other pieces should have a longer dimension equal to the length of the deck. One or more pieces can have both width and length dimensions equal to the width and length dimensions of the deck, such as the L-shaped piece 124.

After a suitable adhesive material is applied to the cut pieces 122, 124, the pieces are stacked one atop another and fitted together in such a fashion that each of the various layers formed by the pieces is of generally uniform thickness, to the extent possible. Each of the pieces generally will partially overlap one or more other pieces. Once the desired total thickness has been built up from the pieces, the entire structure can be compressed by a suitable technique such as by placing the structure between two flat plates and using clamps or other mechanism to press the plates together for a period of time sufficient for the adhesive material to at least partially dry or cure. Pressing could be augmented by heating the plates to dry or cure the adhesive material more quickly and achieve better consolidation of the material.

Any of various adhesive materials can be employed. Suitable examples include but are not limited to water-based adhesives such as dextrin, PVA, sugar adhesives, and sodium silicate adhesives, or thermoset materials such as urea-formaldehyde (UF) resin typically used in the manufacture of particle board.

A second embodiment of a pallet is illustrated in FIG. 4. The shipping member 140 is formed from pieces 142 of used paper material cut into sizes generally greater than about 4×4 inches, and more preferably greater than about 12×12 inches, and the pieces are of different sizes and shapes. Some sheets of the used paper material may be large enough to provide pieces that match the desired length and width of the deck of the shipping member. For example, if the deck is to be 4×4 feet, there may be some sheets of used paper material large enough to provide pieces 4×4 feet in size. More commonly, however, the pieces will be smaller in width and/or length than the deck. Unlike the first embodiment in which the pieces are cut to have complementary shapes, in this embodiment the shapes of the pieces are not taken into account. The sheets of used paper material are cut in the fashion that will afford the maximum usage of the sheets with as little waste or trimmings as possible. Generally, at least some of the pieces should have a longer dimension (i.e., the longer of the width and length) that is equal to the width of the deck, and other pieces should have a longer dimension equal to the length of the deck, although that is not essential. After a suitable adhesive material is applied to the cut pieces 142, the pieces are stacked one atop another in such a fashion that the resulting deck is of as uniform a thickness as reasonably possible. Each of the pieces generally will at least partially overlap one or more other pieces. Once the desired total thickness has been built up from the pieces, the entire structure can be compressed by a suitable technique such as by placing the structure between two flat plates and using clamps or other mechanism to press the plates together for a period of time sufficient for the adhesive material to at least partially dry or cure. Pressing could be augmented by heating the plates to dry or cure the adhesive material more quickly and achieve better consolidation of the material.

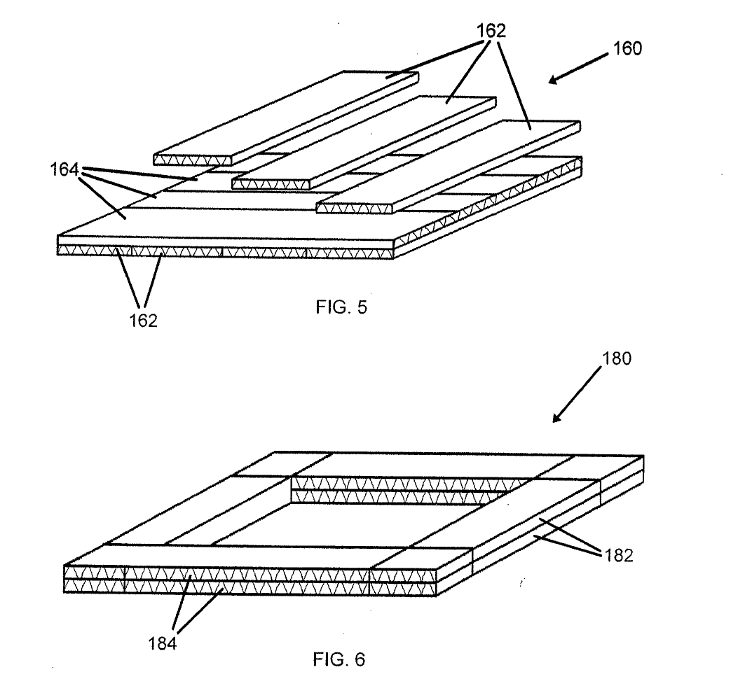

A shipping member 160 in accordance with a further embodiment of the invention is illustrated in FIG. 5. In this embodiment, the sheets of used paper material are cut into strips 162 and strips 164. The strips 162 have lengths equal to the length of the shipping member deck to be formed, but their widths are smaller than the deck width such that a plurality of the strips 162 can be laid side-by-side to make up the desired deck width. Similarly, the strips 164 have lengths equal to the deck width, but their widths are smaller than the deck length such that a plurality of the strips 164 can be laid side-by-side to make up the desired deck length. If the deck is square, then the strips 162, 164 can all be of identical dimensions. The deck is formed by assembling sequential layers, wherein one layer is made up of the strips 162 laid side-by-side with their lengths extending along the lengthwise direction of the deck, and the next layer is made up of the strips 164 laid side-by-side with their lengths extending along the widthwise direction of the deck, i.e., perpendicular to the strips 162. As many layers can be laid up as are needed to achieve the desired deck thickness. The structure is then pressed, with optional heating, as previously described, until the adhesive at least partially dries or cures.

A shipping member 180 in accordance with another embodiment of the invention is shown in FIG. 6. The shipping member 180 has a square or rectangular frame structure formed by strips 182, 184 of used paper material. The strips 182 have lengths equal to the length of the deck to be formed, but their widths are smaller than the deck width. Similarly, the strips 184 have lengths equal to the deck width, but their widths are smaller than the deck length. If the deck is square, then the strips 182, 184 can all be of identical dimensions. The deck is formed by laying the strips 182, 184 (after application of the adhesive material) in a square or rectangular frame configuration, with ends of the strips overlapping each other. For example, a first strip 182 is laid on a plate and a first strip 184 is laid perpendicular to the strip 182 with one end of the strip 184 overlapping one end of the strip 182. A second strip 182 is then laid perpendicular to the first strip 184 with one end of the second strip 182 overlapping the opposite end of the first strip 184. Then a second strip 184 is laid perpendicular to the second strip 182 with one end of the second strip 184 overlapping the opposite end of the second strip 182 and the other end of the second strip 184 being overlapped by the one end of the first strip 182, thus completing a rectangular or square frame. Another layer of the strips 182, 184 is then laid atop the first layer in the same fashion. As many layers can be laid up as are needed to achieve the desired deck thickness. The structure is then pressed, with optional heating, as previously described.

In the shipping members 120, 140, 160, 180 described above, the manufacture of the deck has been described. In some cases, however, the shipping members will require either feet or integral slots in their lower surfaces to allow the tines of a forklift device to be inserted for lifting the shipping member and its load. Accordingly, for any of the shipping members described above, separate feet (not shown) can be made and then affixed to the lower surfaces of the decks using adhesive material. The feet can be made from the used paper material by cutting the used paper material into pieces or strips and adhesively joining the pieces or strips together. As one example, strips of used paper material can be cut and bonded together end-to-end to form a long continuous strip, and the strip can be coated with adhesive material and wound in convolute fashion to form a generally cylindrical foot that can be adhered to a deck. Other methods for forming feet can also be used.

As an alternative to using separate feet, integral slots can be formed in the lower surface of a shipping member deck for receiving forklift tines. The slots can be provided by cutting the pieces of used paper material used for laying up the deck such that the pieces have slots.

Another alternative for providing feet is to lay up the shipping member in a mold that is configured to form integral feet on the deck. After the used paper material pieces have been laid up in the desired fashion in the mold, the mold is closed and pressure is applied to cause the structure to substantially conform to the mold.

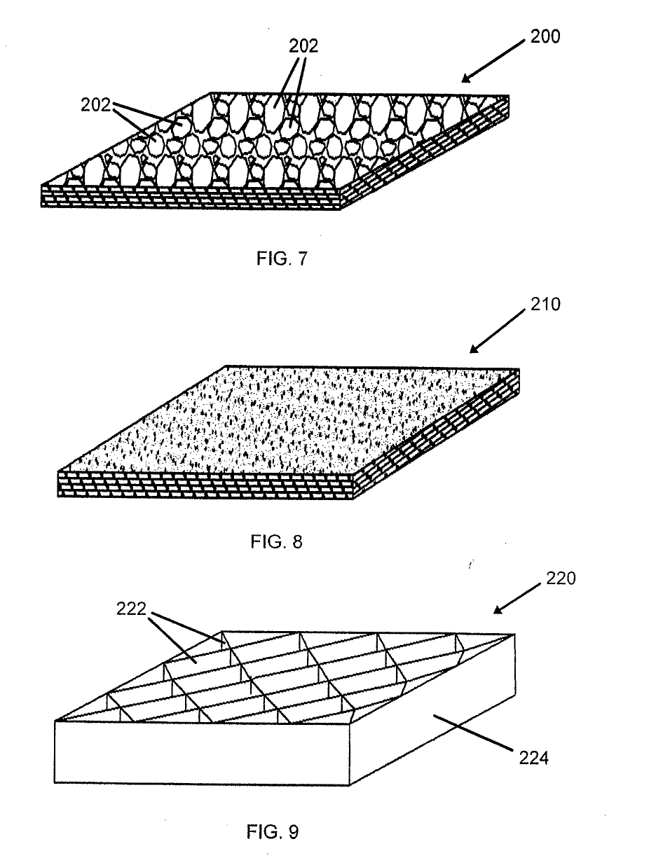

Molded shipping members can also be formed from used paper material that has been shredded or fiberized. For example, FIG. 7 depicts a shipping member 200 made from shredded used paper material. The used paper material is processed in any suitable shredder to shred the used paper material into small pieces 202. The pieces generally are smaller than about 4×4 inches, and more preferably smaller than about 2×2 inches. As an example, the pieces can be about 1×1 inch or smaller. The pieces are coated with adhesive material and are charged into a mold (not shown) configured to form the shipping member's desired configuration. The mold can be configured to form integral feet on the shipping member if desired. The mold is closed and pressure (and optionally heat) is applied until the adhesive material has at least partially dried or cured. The shipping member is then removed from the mold.

Another molded shipping member 210 is shown in FIG. 8. The shipping member 210 is made from used paper material that has been milled or fiberized into a fine fibrous consistency. The fiberized used paper material is blended with adhesive material and is charged into a mold configured to produce the desired shipping member configuration (including integral feet, if desired). The mold is closed and pressure (and optionally heat) is applied until the adhesive material has at least partially dried or cured. The shipping member is then removed from the mold.

A shipping member 220 in accordance with a further embodiment of the invention is shown in FIG. 9. The shipping member 220 is formed by cutting the used paper material into relatively narrow strips 222. The strips are coated with adhesive material and are then assembled with one another to form a cellular or honeycomb type of structure. The width directions of the strips are oriented vertically (perpendicular to the major faces of the structure). When the paper material comprises OCC, the strips are cut such that the corrugations of the OCC extend across the width of the strips, and thus the corrugations extend vertically when the strips are formed into the honeycomb structure. An outer frame 224 formed from one or more strips of the used paper material can surround the honeycomb structure. One or more full-sized sheets of used paper material such as OCC or paperboard (not shown) can be bonded to the upper face (and optionally also the lower face) of the honeycomb structure so as to provide a continuous surface and to enhance the stiffness of the shipping member, if desired. The structure is then clamped or pressed until the adhesive material at least partially dries or cures. Separate feet (not shown) can be attached to the lower surface of the shipping member deck.

In accordance with a method aspect of the invention, when a recipient of paperboard containers filled with new products empties the containers, which then become used paper containers (used paper material), the used paper material is collected. Then, either at the recipient's location or at another location, the used paper material is divided into pieces, the pieces are coated with adhesive material, and the pieces are assembled together to form a shipping member. The shipping members can then be sold to manufacturers and distributors for their use in shipping.

Shipping members such as pallets, trays, corner protectors, edge boards, and the like, and structural panels such as wall boards, furniture or cabinet panels, table tops or countertops, and the like, can be made in accordance with the invention from old corrugated containers (OCC) entirely, predominately (i.e., at least 50% OCC by weight), or partially (i.e., less than 50% OCC by weight). When OCC is mixed with other paper materials to make the shipping members, the other paper materials can comprise one or more of non-corrugated paperboard, various types of paper (e.g., newsprint, packing/cushioning paper, etc.), paper insulation material, and the like. For example, the OCC can be mixed with shredded or fiberized used paper material.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A structural panel, comprising:
a plurality of pieces of used paper material produced by dividing the used paper material into pieces without repulping the used paper material; and
adhesive material coated onto the pieces of used paper material;
the coated pieces of used paper material being assembled together into a layer and joined to one another by the adhesive material to form a structural panel, wherein the coated pieces are respectively randomly oriented in a multitude of different orientations within the layer.

2. The structural panel of claim 1, wherein the structural panel has a width and a length, and wherein at least some of the pieces of used paper material have width and/or length dimensions smaller than the width and/or length of the structural panel.

3. The structural panel of claim 1, wherein the pieces of used paper material comprise strips having a length-to-width ratio between about 5:1 and about 50:1.

4. The structural panel of claim 3, wherein the strips have a width between about 1/16-inch and about ¼-inch and a length between about 1 inch and about 8 inches.

5. The structural panel of claim 4, wherein the panel has a thickness between about ¼-inch and about 1 inch.

6. The structural panel of claim 3, wherein the strips comprise strips of corrugated cardboard that is slit such that a length direction of the strips is non-parallel to a direction in which flutes of the corrugated cardboard extend, such that the strips define a plurality of cells open at side edges of the strips.

7. The structural panel of claim 3, further comprising shredded used paper material blended with the strips.

8. The structural panel of claim 1, wherein the used paper material comprises paper or paperboard contaminated with plastic or wax.

9. The structural panel of claim 1, further comprising a first face sheet adhered to a first surface of the layer.

10. The structural panel of claim 9, wherein the first face sheet comprises a sheet of paper or paperboard.

11. The structural panel of claim 9, further comprising a second face sheet adhered to a second surface of the layer, the layer being sandwiched between the first and second face sheets.

12. The structural panel of claim 11, wherein each of the first and second face sheets comprises a sheet of paper or paperboard.

13. The structural panel of claim 1, wherein the adhesive material comprises a silicate adhesive.

14. The structural panel of claim 13, wherein the pieces of used paper material comprise strips having a length-to-width ratio between about 5:1 and about 50:1.

15. The structural panel of claim 14, further comprising a first face sheet adhered to a first surface of the layer.

16. The structural panel of claim 15, wherein the first face sheet comprises a sheet of paper or paperboard.

17. The structural panel of claim 15, further comprising a second face sheet adhered to a second surface of the layer, the layer being sandwiched between the first and second face sheets.

18. The structural panel of claim 17, wherein each of the first and second face sheets comprises a sheet of paper or paperboard.

19. The structural panel of claim 1, wherein at least some of the pieces have different sizes and/or shapes from one another.

20. A method for making a structural panel, comprising the steps of:
dividing used paper material into pieces without repulping the used paper material;
coating the pieces with an adhesive material; and
assembling the coated pieces together into a layer to form a structural panel, the adhesive material binding the pieces together upon curing or drying of the adhesive material, wherein the assembling step results in the coated pieces being respectively randomly oriented in a multitude of different orientations within the layer.

21. The method of claim 20, wherein the dividing step comprises dividing the used paper material into strips having a length-to-width ratio between about 5:1 and about 50:1.

22. The method of claim 21, wherein the used paper material comprises corrugated cardboard, and the dividing step comprises slitting the corrugated cardboard into strips such that a length direction of the strips is non-parallel to a direction in which flutes of the corrugated cardboard extend.

23. The method of claim 21, wherein the assembling step comprises continuously depositing a layer of the strips coated with the adhesive material onto a moving surface to form a continuous layer of the adhesive-coated strips, the moving surface advancing the continuous layer along a machine direction, and contacting an upper surface of the advancing continuous layer with a pressure member to consolidate the layer and impart a desired thickness thereto.

24. The method of claim 23, wherein the moving surface comprises a continuous face sheet to which the layer of adhesive-coated strips is adhered so as to form a continuous two-layer laminate.

25. The method of claim 24, further comprising adhering a second continuous face sheet to the upper surface of the layer of adhesive-coated strips so as to form a continuous three-layer laminate.

26. The method of claim 23, further comprising advancing the continuous layer to a cutting station at which the continuous layer is cut into desired lengths.
